(19) United States
(12) Patent Application Publication
(10) Pub. No.: US 2010/0328016 A1
(43) Pub. Date: Dec. 30, 2010

(54) SAFE SURGE ABSORBER MODULE

(76) Inventor: Robert Wang, Luch (TW)

Correspondence Address: SINORICA, LLC, 2275 Research Blvd., Suite 500, ROCKVILLE, MD, 20850, US

(21) Appl. No.: 12/490,683

(22) Filed: Jun. 24, 2009

(51) Int. Cl. H01H 85/143; H01H 85/20

(52) U.S. Cl. 337/158; 337/188

(57) ABSTRACT

A safe surge absorber module includes a protective member and a surge absorbing unit. The protective member includes a base and an upper lid coupled to the base. The base has two corresponding partitions extending upwards. The surge absorbing unit includes a body, two connecting feet, and a resilient metallic plate. The body has two sides each defining an electrode surface. The electrode surface is connected with one of the connecting feet. The resilient metallic plate has a first end welded to the electrode surface with a hot melt member and a second end curved and striding across an outer side of one of the partitions to penetrate through the bottom of the base. The connecting feet and the resilient metallic plate are connected to a power source and a circuit load, respectively. In case the body is exploded due to a high temperature, the protective member is adapted to prevent any further accidents which are occurred by the broken fragments.

### BACKGROUND OF THE INVENTION

1. Field of the Invention

The present invention relates to a safe surge absorber module, which is proof against explosion and flame.

2. Description of the Prior Art

In order to avoid a sudden surge (a pulse voltage or a pulse current) which always causes a great influence on electric appliances, most of the electric appliances are provided with a surge absorber for protecting its circuit. In practice, a thermal fuse is connected with the circuit. When the surge absorber is influenced by a surge and has a high temperate, the circuit will be an open circuit to provide an effect on protecting the electric appliance and the surge absorber.

Although the thermal fuse is able to have the surge absorber in an open circuit, it is incapable of having the open circuit happen in a short time. The surge absorber may be exploded and burned to cause the electric appliances damaged or an accident. Accordingly, it is necessary to improve the conventional surge absorber.

### SUMMARY OF THE INVENTION

According to the present invention, there is provided a safe surge absorber module, comprising:

a protective member comprising a base and an upper lid coupled to the base, the base having two corresponding partitions extending upwards and a limit space defined between the partitions; and

a surge absorbing unit comprising at lease one body, at least two connecting feet, and at least one resilient metallic plate, the body being located in the limit space, the body having two sides each defining an electrode surface, the electrode surface being connected with one of the connecting feet, the connecting feet penetrating through a bottom of the base, the resilient metallic plate having a first position and a second position, when the resilient metallic plate is in the first position, the resilient metallic plate having a first end welded to the electrode surface with a hot melt member and a second end curved and striding across an outer side of one of the partitions to penetrate through the bottom of the base, when the resilient metallic plate is in the second position, the hot melt member being melted and the resilient metallic plate disengaging from the hot melt member to form an open circuit relative to the electrode surface.

Thereby, the connecting feet and the resilient metallic plate are connected to a power source and a circuit load, respectively. In case the body is exploded due to a high temperature caused by a surge, the hot melt member will be melted and the resilient metallic plate will disengage from the electrode surface to a predetermined position, preventing the body being influenced by the high temperature. In case the body is exploded, the protective member is adapted to prevent any further accidents which are occurred by the broken fragments.

### BRIEF DESCRIPTION OF THE DRAWINGS

FIG. 1 is a perspective view according to a first preferred embodiment of the present invention;

FIG. 2 is an exploded view according to the first preferred embodiment of the present invention;

FIG. 3 is a cross-sectional view according to the first preferred embodiment of the present invention;

FIG. 4 is a cross-sectional view illustrating the connection of a resilient metallic plate and an electrode surface according to the first preferred embodiment of the present invention;

FIG. 5 is a cross-sectional view illustrating the disconnection of the resilient metallic plate and the electrode surface according to the first preferred embodiment of the present invention;

FIG. 6 is a cross-sectional view according to a second preferred embodiment of the present invention;

FIG. 7 is a cross-sectional view illustrating the connection of the resilient metallic plate and the electrode surface according to the second preferred embodiment of the present invention; and

FIG. 8 is a cross-sectional view illustrating the disconnection of the resilient metallic plate and the electrode surface according to the second preferred embodiment of the present invention.

### DETAILED DESCRIPTION OF THE PREFERRED EMBODIMENTS

Embodiments of the present invention will now be described, by way of example only, with reference to the accompanying drawings.

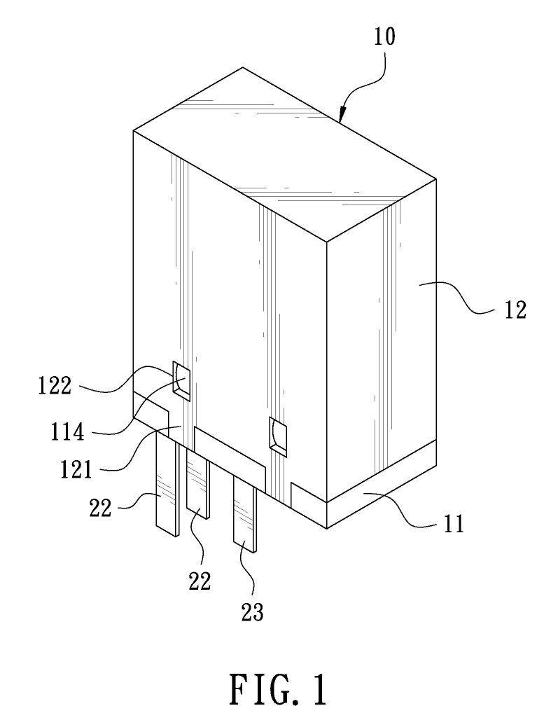

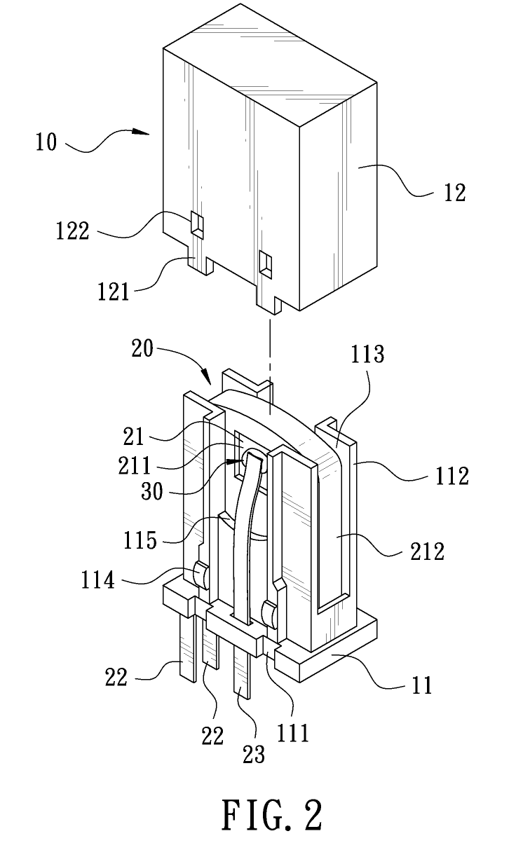

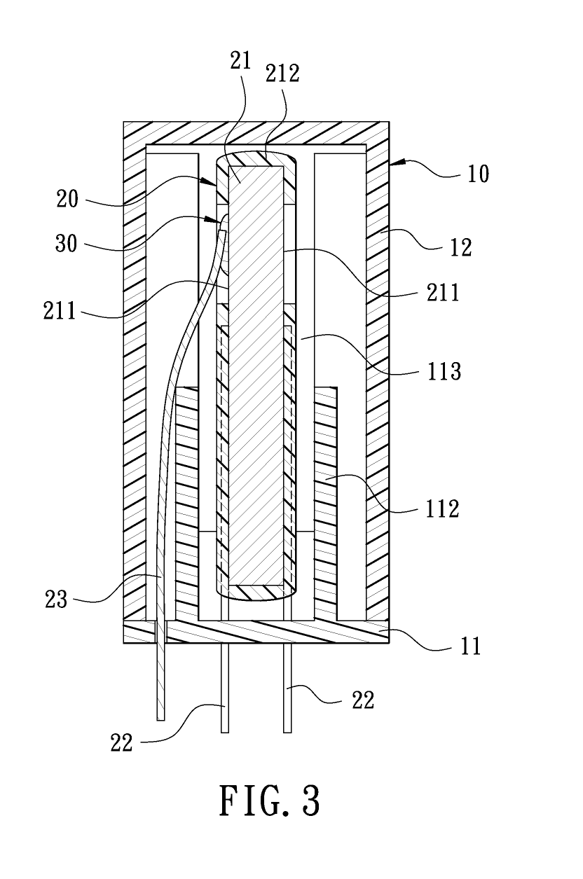

As shown in FIGS. 1 through 3, a first preferred embodiment of the present invention comprises a protective member 10 and a surge absorbing unit 20.

The protective member 10 comprises a base 11 and an upper lid 12 coupled to the base 11. The base 11 has a plurality of notches 111 spaced from each other at a circumferential portion thereof, two corresponding partitions 112 extending upwards, a limit space 113 defined between the partitions 112, flanges 114 disposed on the partitions 112 and located above the notches 111, and a recess 115 formed at a middle portion of each of the partitions 112. The upper lid 12 has tenons 121 and locating holes 122 corresponding in position to the notches 111 and the flanges 114, respectively, so that the upper lid 12 and the base 11 are connected together.

The surge absorbing unit 20 comprises a body 21, two connecting feet 22, and a resilient metallic plate 23. The body 21 is made of zinc oxide material and located in the limit space 113. The body 21 has two sides each defining an electrode surface 211. The electrode surface 211 is connected with one of the connecting feet 22. The connecting feet 22 penetrate through a bottom of the base 11. The body 21 is wrapped with epoxy resin 212. The epoxy resin 212 also wraps upper sections of the connecting feet 22. The epoxy resin 212 provides an insulation effect. A first end of the resilient metallic plate 23 is welded to the electrode surface 211 with a hot melt member 30. The hot melt member 30 is a solder. A second end of the resilient metallic plate 23 is curved and strides across an outer side of one of the partitions 112 to penetrate through the bottom of the base 11. The resilient metallic plate 23 is in a first position under this connecting state.

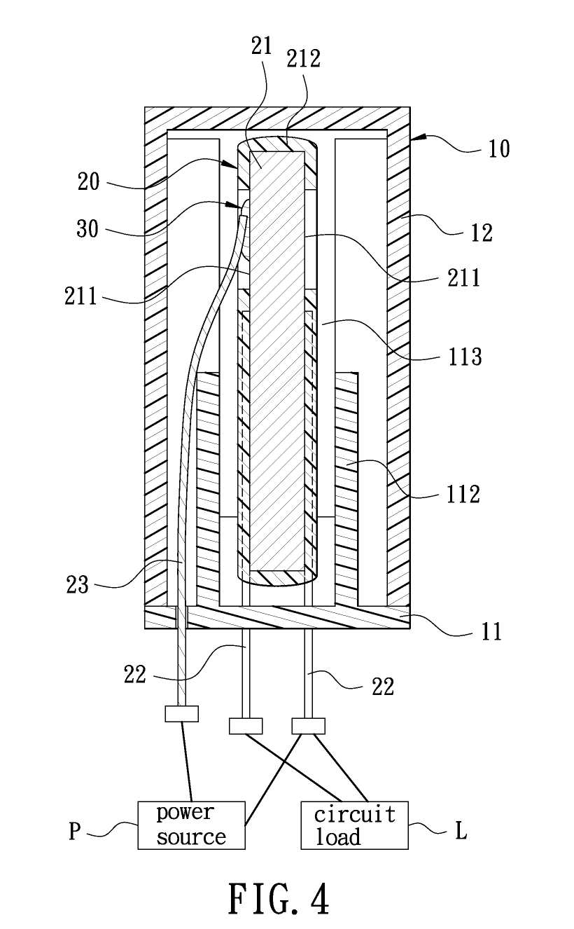

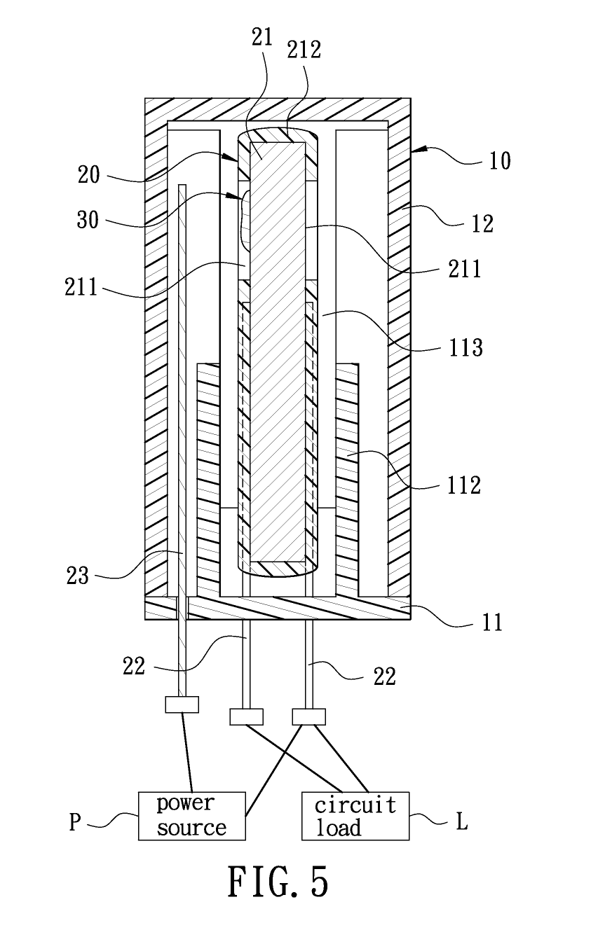

FIGS. 4 and 5 are schematic views illustrating the first preferred embodiment of the present invention in use. The resilient metallic plate 23 and one of the connecting feet 22 are connected to a power source P, while the connecting feet 22 are connected to a circuit load L. When the power source P is struck by lightning or other reasons to generate a surge, the surge will enter into the body 21 through the resilient metallic plate 23 and one of the connecting feet 22 to generate heat energy. When the heat energy generated from the body 21 is too high, the hot melt member 30 welded to the electrode surface 211 will be melted and the resilient metallic plate 23 will disengage from the hot melt member 30 to a predetermined position. The resilient plate 23 and the electrode surface 211 generate an open circuit. The resilient metallic plate 23 is in a second position under this connecting state. The input route of the power source P is in a broken state so as to protect the circuit load L. The hot melt member 30 has a lower melting point so that the resilient metallic plate 23 is able to disengage from the electrode surface 211 in a short time to break the circuit. In addition, one of the partitions 112 is located between the body 21 and the resilient metallic plate 23 for providing an effect to isolate an electric arc. In case the body 21 is exploded due to a high temperature, the upper lid 12 entirely covers the body 21 to prevent any further accidents which are occurred by the broken fragments.

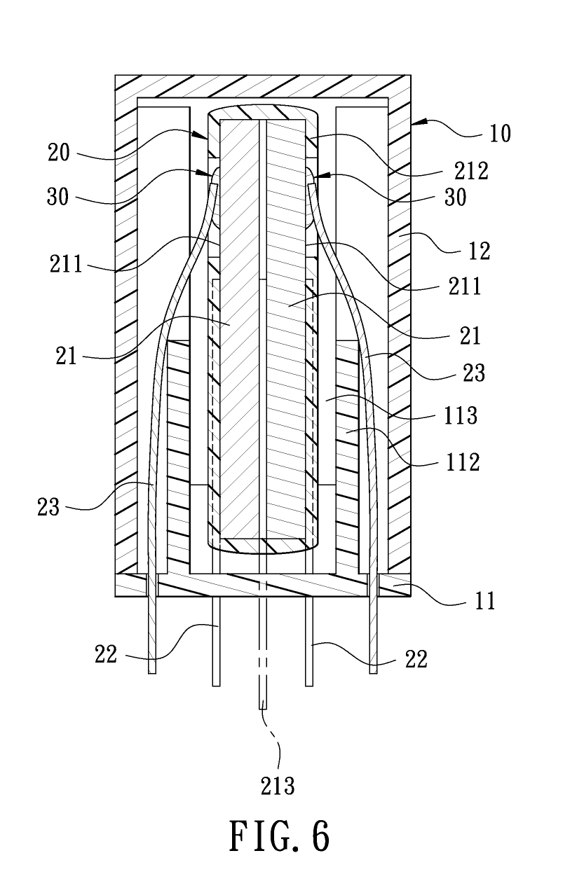

FIG. 6 is a cross-sectional view according to a second preferred embodiment, which is substantially similar to the first preferred embodiment with the exceptions described hereinafter. The surge absorbing unit 20 comprises two bodies 21, two connecting feet 22, and two resilient metallic plates 23. The two bodies 21 are stacked, and a common foot 213 is provided between the two bodies 21. The two connecting feet 22 are connected to two opposing outer sides of the two bodies 22. Each of the resilient metallic plates 23 has a first end welded to the electronic surface 211 and a second end striding across the partition 112 and penetrating through the base 11.

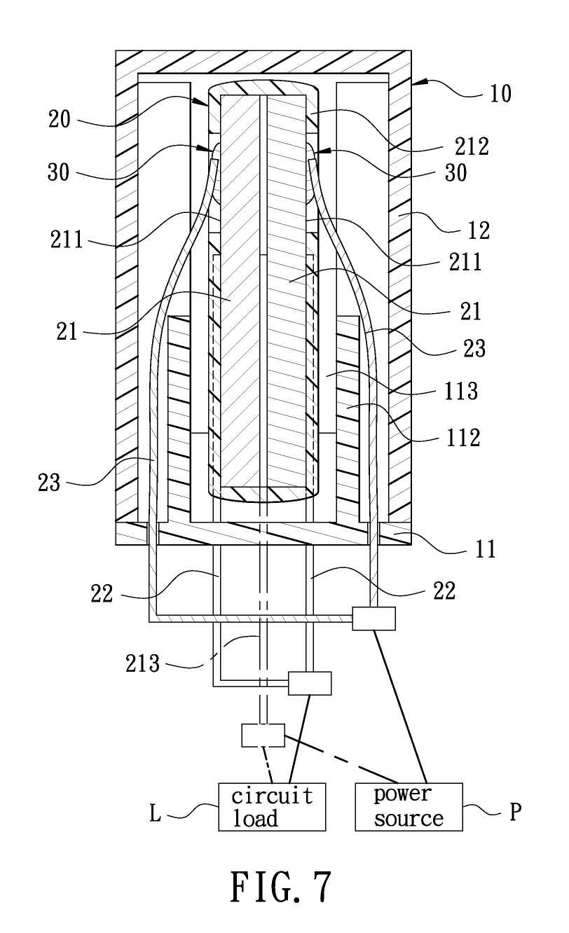

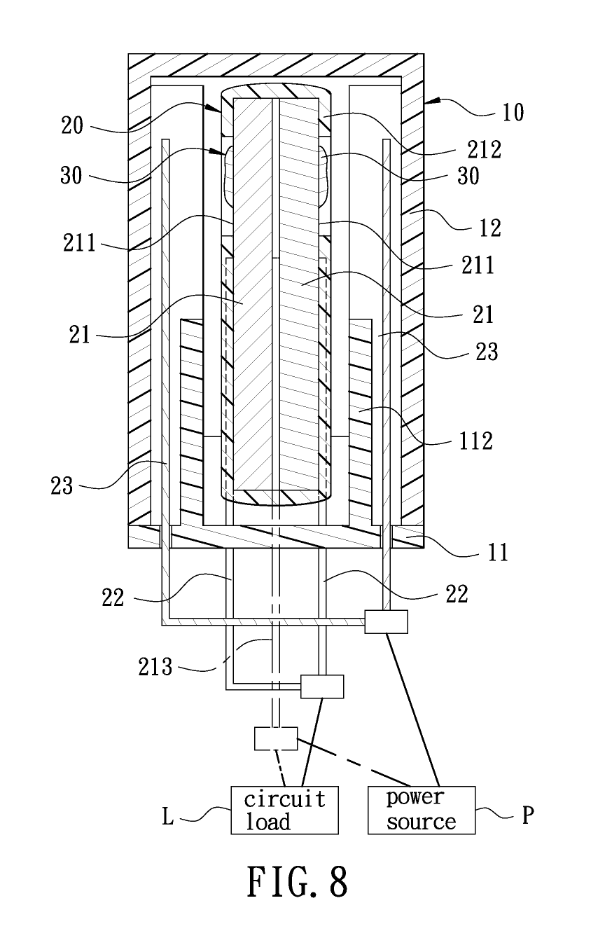

FIGS. 7 and 8 are schematic views illustrating the second preferred embodiment of the present invention in use. The power source P is connected in parallel with the resilient metallic plates 23 and the common foot 213, while the circuit load L is connected with the connecting feet 22 and the common feet 213. With the connecting way of this embodiment, the bodies 21 enhance the surge load and decrease suppressor current. When the heat energy generated from the bodies 21 due to the surge exceeds the melting point of the hot melt member 30, the resilient metallic plates 23 will disengage from the hot melt member 30 to a predetermined position. The input route of the power source P is in a broken state.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A safe surge absorber module, comprising:
a protective member comprising a base and an upper lid coupled to the base, the base having two corresponding partitions extending upwards and a limit space defined between the partitions; and
a surge absorbing unit comprising at lease one body, at least two connecting feet, and at least one resilient metallic plate, the body being located in the limit space, the body having two sides each defining an electrode surface, the electrode surface being connected with one of the connecting feet, the connecting feet penetrating through a bottom of the base, the resilient metallic plate having a first position and a second position, when the resilient metallic plate is in the first position, the resilient metallic plate having a first end welded to the electrode surface with a hot melt member and a second end curved and striding across an outer side of one of the partitions to penetrate through the bottom of the base, when the resilient metallic plate is in the second position, the hot melt member being melted and the resilient metallic plate disengaging from the hot melt member to form an open circuit relative to the electrode surface.

2. The safe surge absorber module as claimed in claim 1, wherein the body is wrapped with epoxy resin, and upper sections of the connecting feet are wrapped by the epoxy resin.

3. The safe surge absorber module as claimed in claim 1, wherein each of the partitions is formed with a recess at a middle portion thereof, the resilient metallic plate having the first end welded to the electrode surface and the second end striding across one of the partitions via the recess and penetrating through the base.

4. The safe surge absorber module as claimed in claim 1, wherein the base has a plurality of notches spaced from each other at a circumferential portion thereof, the partitions have corresponding flanges disposed above the notches, and the upper lid has tenons and locating holes corresponding in position to the notches and the flanges, respectively, for the upper lid to be coupled to the base.

5. The safe surge absorber module as claimed in claim 1, wherein the surge absorbing unit comprises two bodies, two connecting feet, and two resilient metallic plates, the two bodies being stacked, a common foot being provided between the two bodies, the two connecting feet being connected to electrode surfaces defined at two opposing sides of the two bodies, the resilient metallic plates each having the first end welded to one of the electronic surfaces and the second end striding across one of the partitions and penetrating through the bottom of the base.

6. The safe surge absorber module as claimed in claim 1, wherein the hot melt member is a solder.
